(19) United States
(12) Patent Application Publication
(10) Pub. No.: US 2017/0184070 A1
(43) Pub. Date: Jun. 29, 2017

(54) Tidal flow power generation System and Method

(71) Applicant: Leon Clyde Blasingame, Hampton, VA (US)

(72) Inventor: Leon Clyde Blasingame, Hampton, VA (US)

(21) Appl. No.: 14/998,046

(22) Filed: Dec. 24, 2015

(51) Int. Cl. F03B 3/12; H02K 7/18; F03B 11/06

(52) U.S. Cl. CPC F03B 3/12; F03B 11/06; H02K 7/1823; F05B 2220/706; F05B 2260/4031

(57) ABSTRACT

A tidal stream impeller generator. The generator is a closed container, housing generators and related equipment in a non-flammable environment. The generator housing has affixed to it impeller blades, oriented to maximize the force captured from the movement of seawater with tides at depth. The housing and impeller blades rotate about a conduit, the conduit serving as an axle as well as a conduit for cables, pipes, and related structures to enter the housing without breaching the watertight housing. The conduit passes through end caps on the housing, through watertight bearings.

### BACKGROUND OF THE INVENTION

Power demands are increasing globally at the same time that concerns over pollution and unrenewable and unsustainable sources of power are rising. One source of energy that has been considered is the ocean. Various concepts have been considered, including ocean thermal energy, wave energy conversion, and tidal flow energy conversion. Harnessing energy from the ocean, however, must overcome significant design and implementation the production of electricity from the tidal flow of ocean tributaries.

Historically tidal power has been viewed as a viable solution for renewable energy because tidal flows are driven by the gravitational interaction between the Earth and Moon; this source of energy is likely inexhaustible and therefore is an extremely attractive potential solution to renewable and sustainable energy concerns. Tidal stream generators make us of the kinetic energy in the tidal movement of bodies of water. There are various designs of tidal stream generators, but they suffer from mechanical losses and fail to efficiently capture the available energy.

The production of energy from tidal flow from ocean tributaries requires the solution of several problems. First, it is necessary to design impeller blades that provide the maximum surface at 90 degrees to the current flow for maximum efficiency and the greatest power output. Utilizing designs that constantly expose a large surface area while maintaining a 90 degree aspect to the current flow—and thus to the maximum force of a moving current—is a difficult problem but one that, if solved, provides the greatest potential capture of kinetic energy contained in tidal flows. Second, the impeller housing must be constructed in such a manner as to reduce the wear from exposure to moving salt water. Salt water alone is corrosive but in an environment where a mechanism relies upon moving salt water, the corrosive effects can be multiplied along with wear and tear from the movement of salt water across exposed surfaces. The salts and particulate matter carried in seawater increases the erosion naturally caused by water flowing across surfaces. This harsh environment can reduce the lifetime of a device. Therefore, any tidal stream generator must take into account the destructive environment, and be designed to provide maximum protection from the corrosive elements of a salt water environment and have the mechanical and electrical systems contained in a closed container, offering complete fire protection for the electric generator and other electronic component.

Third, it must produce a product that will supply a huge demand in the market place. The best use for the electricity could be used to manufacture hydrogen gas from salt water. Currently, the most common commercial hydrogen gas production process uses natural gas as the hydrogen source. This process is expensive and the by products are a pollution problem. Having a power source located at a salt water source will allow the utilization of the power to efficiently produce hydrogen. Even without applying the power to the production of hydrogen, capturing the limitless kinetic energy of tides and converting to energy for commercial and/or household use is advantageous in and of itself.

The present invention is a high torque, extreme length impeller generator. In a preferred embodiment, the impeller blades are constructed of high strength, non-corrodible materials, such as carbon fiber. It is also preferred that the housing for the generators are made from the same or similar material. As designed herein, the carbon fiber generator housing is tubular, and may be constructed to be between fifteen and fifty feet in diameter, depending upon the chosen application and the location chosen for installation. Space and environmental considerations will dictate, in part, the size of the impeller generator.

The electrical generators and associated electrical equipment are housed within the carbon fiber cylinder. The ends of the carbon fiber cylinder are covered with a watertight cap, penetrated by a shaft through a watertight bearing fixture.

In one embodiment, it is preferable to have the cylinder filled with a pure nitrogen atmosphere, thereby negating any fire risk.

In operation, the invention takes advantage of Pascal's Law and that water density increases with depth. Pascal's Law provides that pressure acting on a confined fluid is transmitted equally and undiminished in all directions. As a result, the force on a particular portion of water in the water column is transmitted equally both vertically and horizontally. It is the horizontal force which is utilized by the present invention as the motive force for the one or more electrical generators contained in the present invention.

In an example, an impeller blade one (1) foot wide and one hundred (100) feet long at the depths of one foot, thirty three feet, and ninety-nine feet feels the following forces:
1 ft depth: H₂O density of 64 lbs/ft³×100 ft²=6,400 lbs total force (3.2 tons)
33 ft depth: H₂O density of 4,232 lbs/ft3×100 ft2=423,200 lbs total force (21.4 tons)
99 ft depth: H₂O density of 8,462 lbs/ft3×100 ft2=846,200 lbs total force (423.2 tons)

With no movement of the water column, the force on either side of the impeller blade cancels each other out, resulting in a net zero movement. Moving water, however, produces a force equal to the water density multiplied by the surface area and the velocity of the water. At depth, therefore, the force exerted against a surface is many times the force exerted by stationary water at depth, and because the tidal flow causes the water body to move in a particular direction, the tidal force can be utilized to move an impeller.

What is needed, therefore, is an impeller-generator combination that is 1) specifically designed to efficiently capture the force exerted by the tidal movement of water and 2) that can be safely operated within a salt-water environment and be monetarily feasible.

### BRIEF DESCRIPTION OF THE DRAWINGS

FIG. 1 shows a view of the interior of an embodiment of the present invention as seen from above.

FIG. 2 shows an exeterior view of an embodiment of the present invention.

FIG. 3 shows a view from the end of an embodiment of the present invention.

FIG. 4 shows a view of structural conduit in accordance with an embodiment of the present invention.

FIG. 5 shows a side view of the conduit in accordance with an embodiment of the present invention.

FIG. 6 shows a top-down view of an impeller in accordance with an embodiment of the present invention.

FIG. 7 shows a detail of a power blade in accordance with an embodiment of the present invention.

FIG. 8 shows a detail cutaway view of a structural spacer in accordance with an embodiment of the present invention.

FIG. 9 shows a cutaway of an embodiment of the present invention.

FIG. 10 shows detailed views of the housing—end cap combination in accordance with an embodiment of the present invention.

FIG. 11 shows an interior cutaway of a low maintenance impeller cutaway in accordance with an embodiment of the present invention.

FIG. 12 shows a side view cutaway of a low maintenance impeller in accordance with an embodiment of the present invention.

FIG. 13 shows a flange in accordance with an embodiment of the present invention.

FIG. 14 shows a structural foundation in accordance with an embodiment of the present invention.

### DETAILED DESCRIPTION OF A PREFERRED EMBODIMENT

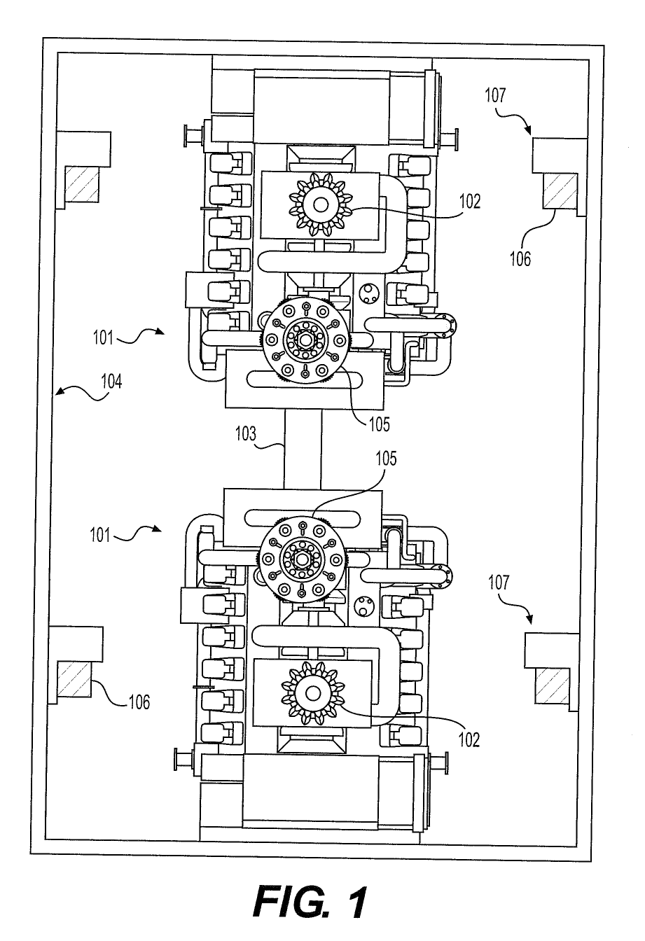

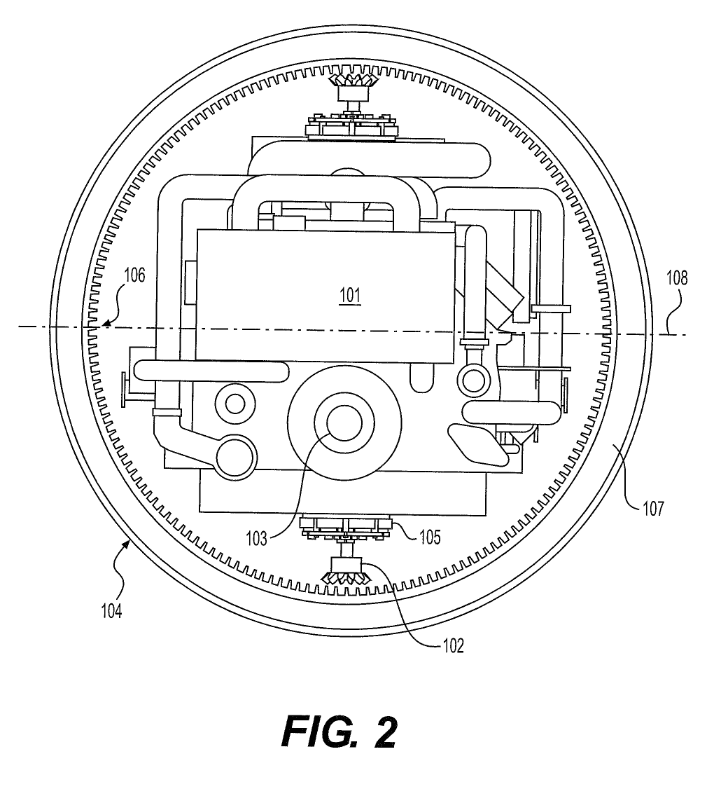

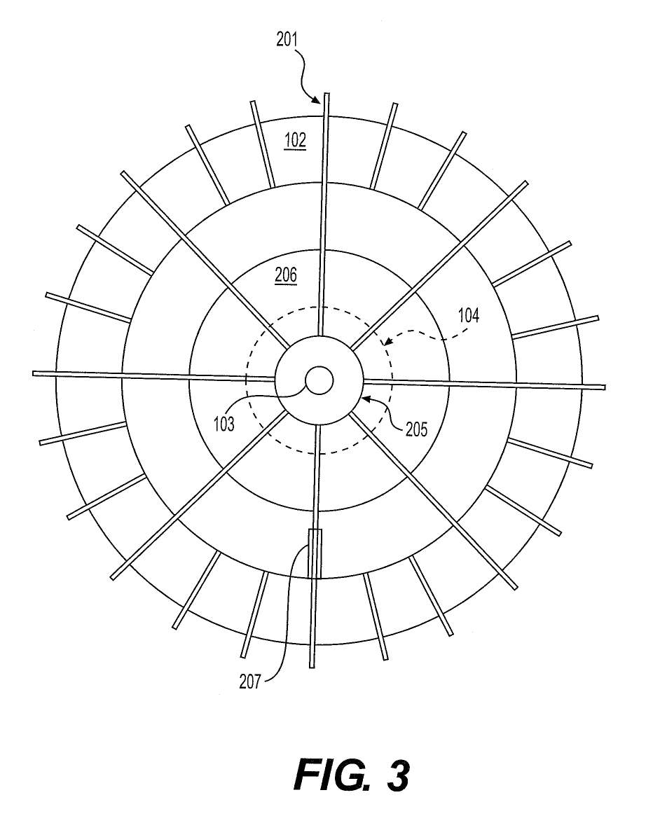

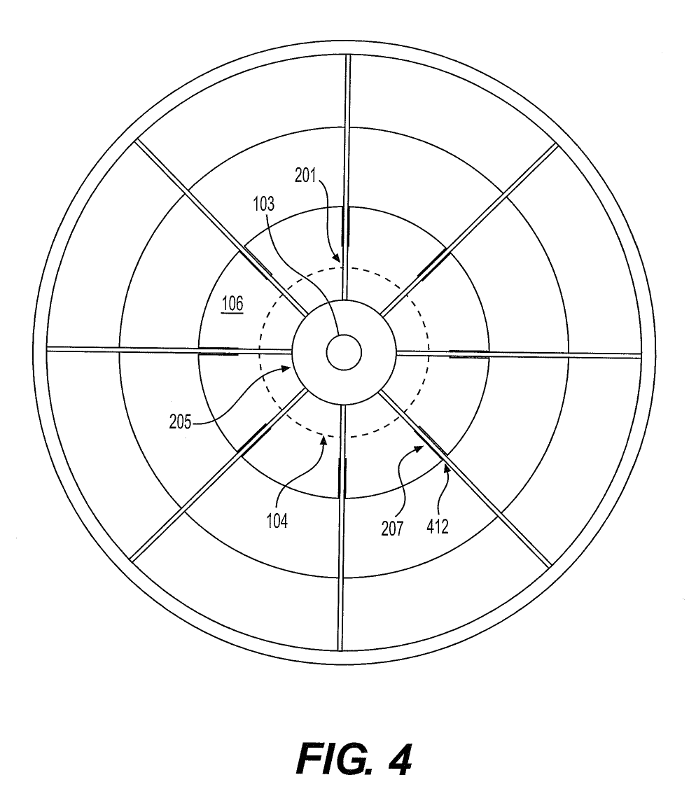

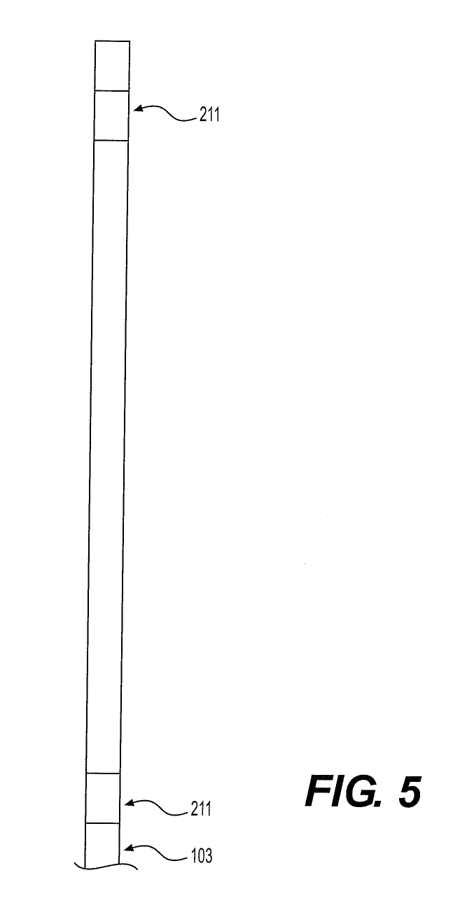

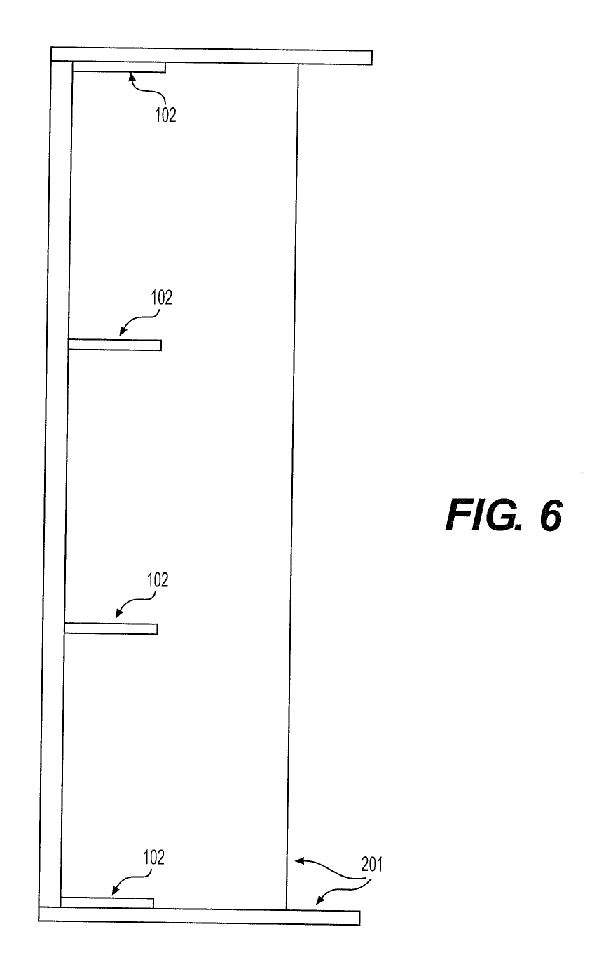

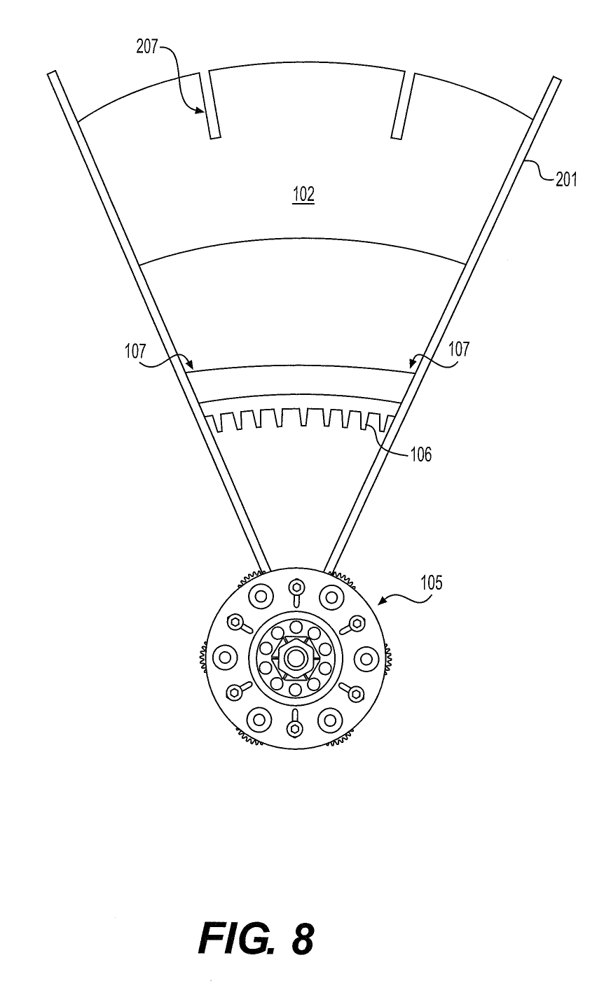

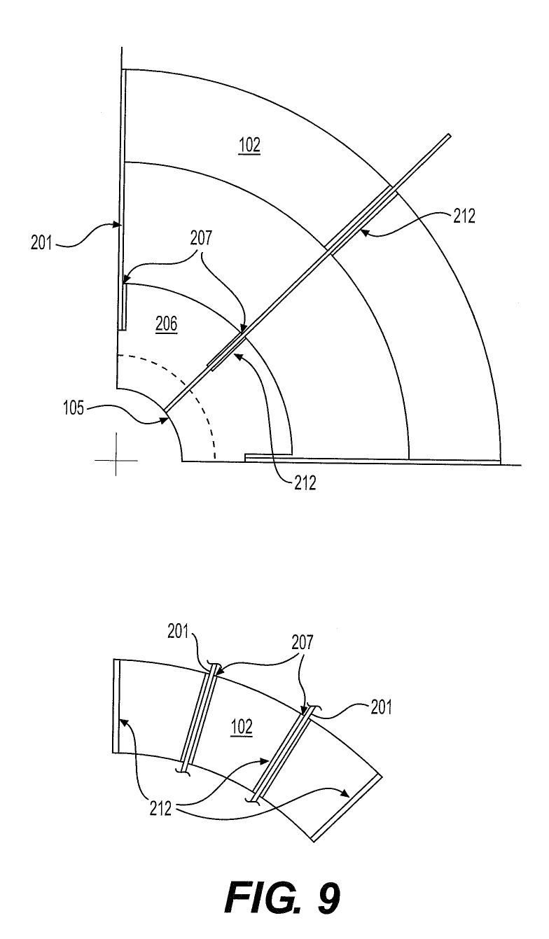

Referring now to FIGS. 1 and 2, FIG. 1 showing a side view of the present invention and FIG. 2 showing an end-on perspectives. The invention as shown comprises a pair of electric generator 101. A power gear 102 is mechanically meshed with a rim gear 106. A structural conduit 103 serves as an axle, which rotates when force is applied to the impellers (not shown in this Figure). Force on the impellers causes rotation of the conduit 103, which in turn imparts rotational force on the rim gear 106, transmitting rotational forces to the power gear 102 which, in turn, imparts rotational force on the generators. Also shown is a transmission gear box 105, used to control the rotational speed applied to the generators 101. The rim gear 106 is attached to a circular frame 107, which is mechanically attached to or molded as a portion of the generator housing 104. A structural spacer 102 serves as the foundation to which the power blades 102 are mechanically secured, allowing additional impeller blades, FIG. 3, 201, to be added to the invention. FIGS. 3-9 show detailed views of the construction of an embodiment of the present invention, detailing the structure of the blades 201 in relation to the conduit 103, the housing 104, spacers 102 and the end cap 206. In an embodiment where there are two or more generators 101, the generators 101 are operated in mechanical series by mechanical connection with the conduit 103 serving as an axle.

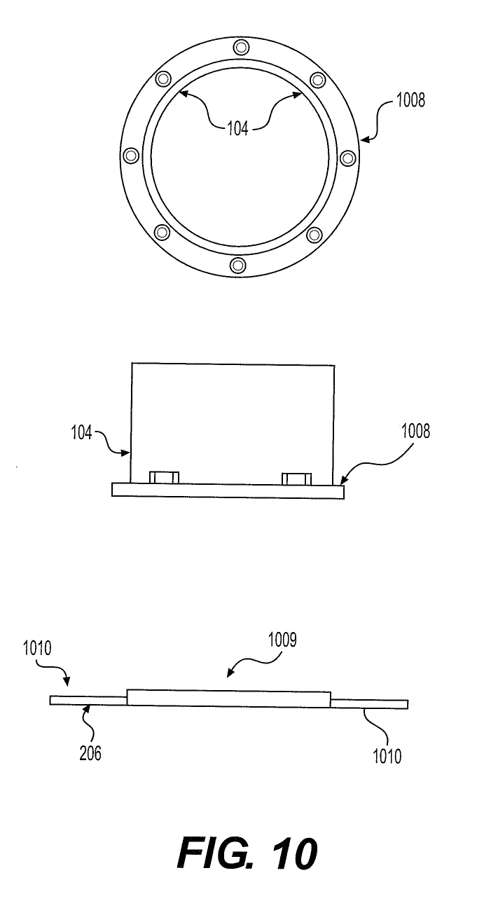

The structural end cap 206 is penetrated by the conduit 103. The main impeller blades 201 are mechanically affixed to the end cap 206. The end cap 206 mechanically secures the main impeller generator body 204 to the end cap 206. The impeller blades 201 are secured to the conduit 103, such that when the device is in operation, rotation of the impeller blades 201 imparts rotational force on the conduit 103, thereby imparting rotational force on the generator shafts. The end cap 206 further contains a bearing 211 through which the conduit 103 passes, providing a watertight closure that still allows the conduit 103 to rotate when force is applied to the impeller blades 201. It will be understood that there are two (2) end caps 206, one at each end of the device housing 104. Each cap will contain a bearing 211. Watertight bearings are well known in the art, such as those used for ship and submarine drive shafts. The end cap 206, when viewed from the top down (FIG. 10) shows that the center portion 1009 is thicker than the edge portion 1010. This allows the end cap 206, when fitted to the end of the housing 104, to have the center portion 1009 fit within the circumference of the housing 104, and the edge portion 1010 joins flush with the joining flange (FIG. 10, 1008). Contained within the housing 104 is electrical equipment electrically connected to the generators, allowing for electrical control and harvesting of electrical power from the generators 101. Such control and harvesting systems are well known in the industry, and one skilled in the art will understand that such systems may be constructed in any number of configurations without deviating from the scope and intent of the present invention.

The structural conduit 103 has two functions. First, the conduit serves as an axle to which the shaft(s) of the generators 101 are attached, transmitting rotational force to the generators 101 to create electricity. The conduit 103 further provides a hollow interior portion in which electric cables, pipes, and other supporting structures enter the housing 104 in which the generators 101 are housed. The conduit further allows nitrogen gas to be sent into the housing 104 to provide an inert atmosphere, preventing fire within the housing 104.

The circular stop 205 keeps the main impeller blades 201 equal in distance from the centerline of the axle 103. Slot 207 is formed in the end cap 206, the slot 207 securing the impeller blades 201 with a structural flange 212. An impeller generator 204 is mechanically affixed to the end cap 206. A structural stop 205 maintains uniform distance from the stop 205 to the outboard edge 209 of each of the impeller blades 201.

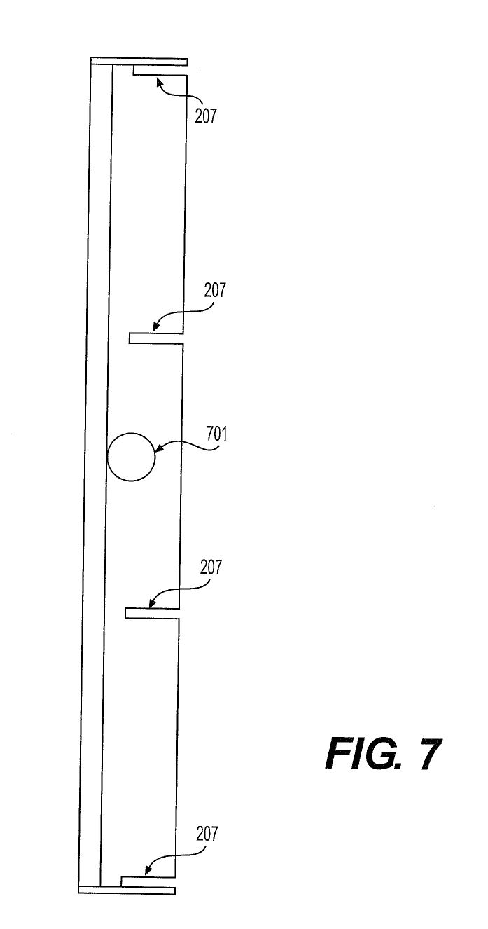

FIG. 7 shows a detail for a power blade 701 includes slots 207, allowing for rapid installation of the power blade 701 onto the structural spacer 102.

FIG. 10 is a view of a housing 104—end cap 206 combination. Joining flange 1008 around the circumference of the housing 104 allows the end cap 206 to cover the end of the housing 104, with the edge portion 1010 of the end cap 206 to join flush with the joining flange 1008, while the center portion 1009 of the end cap 206 is disposed within the circumference of the housing 104.

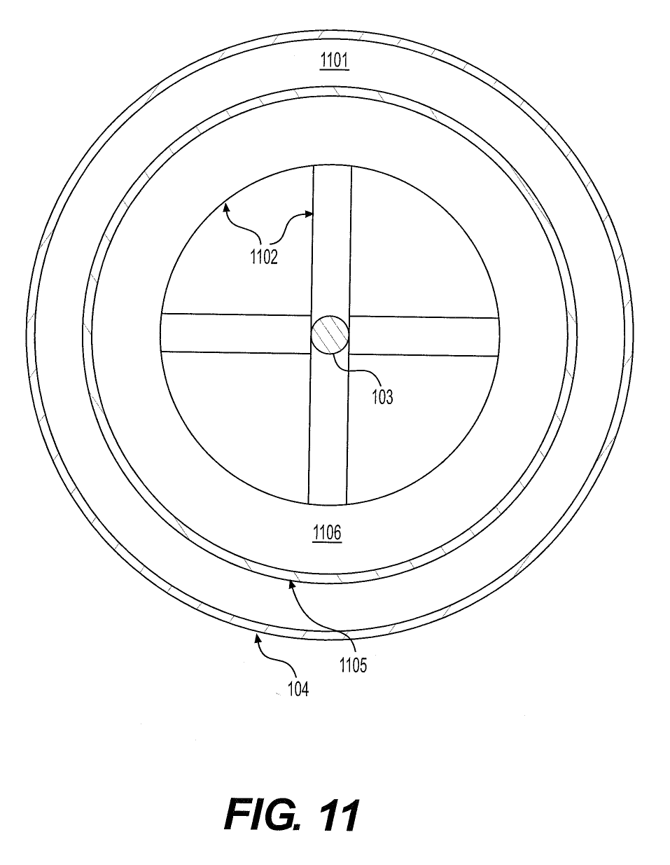

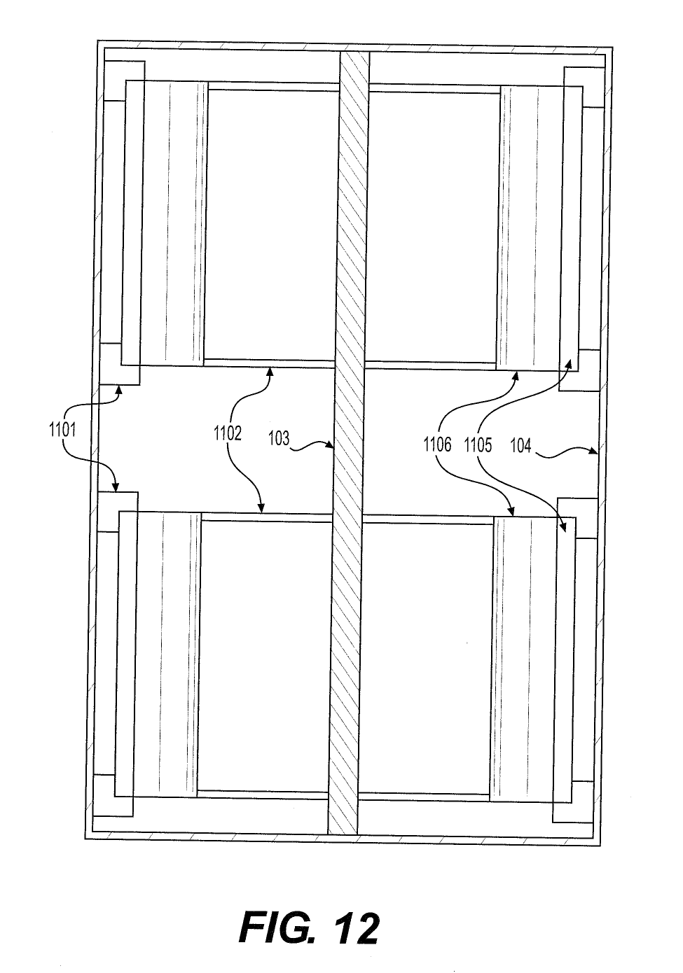

Referring now to FIG. 11, a low-maintenance impeller option is shown as an interior cutaway. The conduit 103 is shown, as is a tubular foundation 1102 which supports the generator coil windings 1106. Generator magnets 1105 are mechanically secured to a circular frame 1101, which rotates with the housing 104. In this embodiment, the conduit 103 serves as an axle for the rotating housing 104. The magnets 1106 do not rotate with the housing 104. FIG. 12 is another view of FIG. 11, shown as a cutaway view from the side rather than end-on as FIG. 11 is shown.

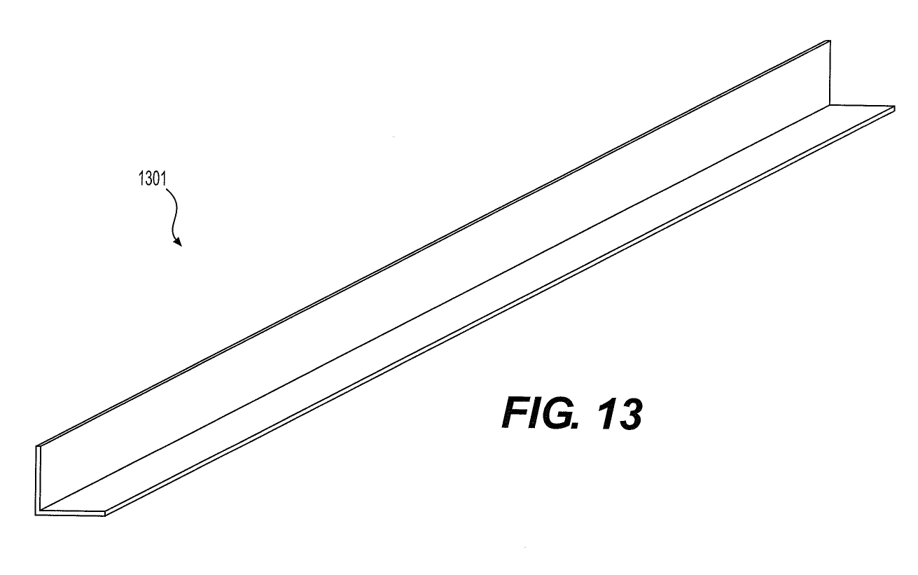

FIG. 13 is a view of a structural flange, 1301. The flange 1301 is used to install the power blades (FIG. 7, 701) to the spacer 102.

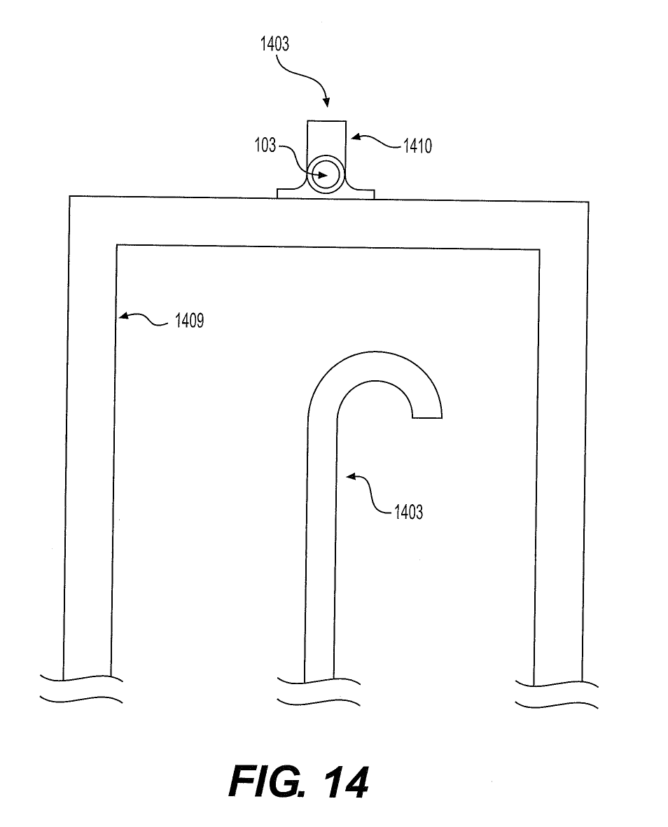

FIG. 14 shows a view of a structural foundation for the impeller generator of the present invention. The rigid support structure 1409 is secured by well-known means to an ocean/water body floor at the structural ends 1402. The conduit 103 is positioned on top of the support structure 1409, with structural elbows 1410 mechanically securing the conduit 103 to the support structure 1409. The conduit extension 1403 is curved, thereby changing the direction of the conduit 103 from the horizontal to the vertical portion 1404, the vertical portion 1404 being the point of entrance for electrical cables, pipes, etc. to enter the housing (104—not shown in this view). Two extensions 1403 are utilized in a preferred embodiment, one at each horizontal end of the conduit 103.

This invention has been described in enough detail that one skilled in the art will be able to reproduce it without difficulty. There are modifications and equivalent structures and designs that can be incorporated without deviating from the scope of the invention.

1. A tidal flow power generator, comprising
A housing;
One or more electrical generators contained within the housing, the generators having a common axle;
The common axle being comprised of a conduit, the conduit having an interior hollow portion;
The housing being tubular, having a flange at each end, and having end caps, the end caps comprised of a raised center portion and a flange such that the end caps seat into the ends of the housing;
The end caps having watertight bearings positioned through the center of the end caps, the conduit passing through the end caps;
One or more impellers, the impellers being mechanically attached to the conduit on the exterior of the end caps;
Impeller blades mechanically affixed to the impeller;
Electrical equipment located inside the housing, the electrical equipment providing control and power harvesting for the one or more generators; and
Control and power cables running through the conduit to the interior of the housing.

2. The tidal flow power generator of claim 1 wherein nitrogen gas is passed through the conduit to the interior of the housing.

3. The tidal flow generator of claim 1 wherein the conduit further comprises one or more conduit extensions, the conduit extensions being curved with an open end vertically positioned with regard to the horizontal axis of the conduit, the open end of the extensions providing points of entrance for electrical cables, pipes, and other service structures.

4. The tidal flow generator of claim 1 further comprising a structural foundation, the structural foundation comprising a support structure with structural ends secured to the floor of a body of water, structural elbows positioned on the top of the support structure, the structural elbows mechanically securing the conduit to the top of the support structure in such a manner that the conduit may still rotate when tidal force against the impeller blades causes rotation of the impellers.

5. The tidal flow generator of claim 1 wherein the impellers further comprise one or more structural spacers to which the impeller blades are mechanically attached.

6. The tidal flow generator of claim 5 wherein the impellers further comprise spaces for additional impeller blades to be installed.

7. The tidal flow generator of claim 1 further comprising a power gear mechanically meshed with a rim gear, the rim gear mechanically attached to a transmission gear box that is mechanically attached to the one or more generators.
